(19) United States
(12) Patent Application Publication
(10) Pub. No.: US 2004/0220864 A1
(43) Pub. Date: Nov. 4, 2004

(54) Method and system for competing against an established online marketplace

(76) Inventor: Steven Gregory Popovitch, Ann Arbor, MI (US)

Correspondence Address: STEVEN POPOVITCH, 704 N. CHIPMAN, OWOSSO, MI, 48867, US

(21) Appl. No.: 10/429,118

(22) Filed: May 2, 2003

(51) Int. Cl. G06F 17/60

(52) U.S. Cl. 705/27

(57) ABSTRACT

A method and system is disclosed which allows a smaller competitor online marketplace to efficiently compete against an established online marketplace. A software application, which allows to directly interact and conclude transaction with online marketplaces, is distributed as widely as possible to end-users. It is expected that initially, users will use the software application mostly for interacting with the established online marketplace. However, by seamlessly displaying items available for sale in the competitor online marketplace within the software application, the users of this software application become buyers in the competitor online marketplace, allowing it to reach the critical mass of buyers necessary to attract a large number of sellers.

### FIELD OF THE INVENTION

The disclosed invention relates generally to electronic commerce, and in particular to the operation of online marketplaces.

### BACKGROUND OF THE INVENTION

Online marketplaces are online services where items can be bought and/or sold. There are several types of online marketplaces, including: online auctions; online fixed-price listing services; and online stores. Online marketplaces share common attributes. They are usually powered by multi- user computer systems running database software, which are used to publish a web site on the Internet. Through the use of a web browser, a multitude of users can browse this web site, view items available for sale, and purchase items.

In most online marketplaces, items available for sale are classified by categories. This classification of items into categories makes it easier for buyers to browse the items currently available, as they can focus on the categories relating to their interest. Yet, in the most successful online marketplaces, millions of items may be offered at any given time, and a category may contain thousands of items. In order to help prospective buyers to locate items they might be interested in, online marketplaces typically include a search feature. This feature allows users to perform text searches (possibly including wildcards and Boolean expressions) on the current listings titles, descriptions and attributes such as price, or search for a precise product identifier such as an UPC code or a manufacturer's reference number.

It is possible to differentiate between two general groups of online marketplaces: Consumer-To-Consumer (C2C) marketplaces, where a multitude of web site users are responsible for listing and shipping items for sale; and Business-To-Consumer (B2C) marketplaces, where the company running the web site is the seller of the advertised items. The most common types of online marketplaces are:

An online store is a type of Business-To-Consumer online marketplace. The company running the online store is responsible for: listing new items; receiving payments from visitors who complete a purchase; and delivering purchased items to those visitors. At any one time, each item can be purchased for a predetermined price. Examples of online stores are: the online store operated by Barnesandnoble.com LLC; the online store operated by Buy.com, Inc; online travel agents such as Expedia Inc. or Travelocity.com.

A fixed-price listing service is a type of Consumer-To- Consumer online marketplace. The company running the web site is not the seller of the items available on the online marketplace, but allows web site users to list items for sale. In some cases, the company may process the payments when visitors purchase items, but the seller is normally responsible for shipping the purchased items. At any one time, each item can be purchased for a predetermined price. Examples of fixed-price listing service are: the service provided by Half.com, Inc.; the used marketplace of Amazon.com, Inc; the used book marketplace Abebooks.

An online auction marketplace is a type of online marketplace where the price of items may change following a predefined bidding protocol. Online auction marketplaces can be either Consumer-To-Consumer marketplaces, where web site users are responsible for listing and shipping items, an example of which is the online auction marketplace operated by eBay Inc.; or Business-To-Consumer (B2C) marketplaces where the company running the online auction marketplace (or a small number of partner companies) is the seller of the advertised items, an example of which is the online auction marketplace operated by uBid Inc.

An online shop aggregator is a type of online marketplace where a company provides a facility allowing a multitude of individuals or organizations to create their own online shops, usually in exchange for a monthly fee and/or a percentage of the sales. Examples of online shop aggregator are: the zShops from Amazon.com, Inc.; the Yahoo! Inc. shops. An online shop aggregator can be considered to be a Consumer-To-Consumer online marketplace, as a multitude of end-users are responsible for listing and shipping items for sale.

Consumer-To-Consumer online marketplaces naturally tend to become de-facto monopolies. The online marketplace which has the largest number of items available for purchase will naturally attract more buyers, as they will have a better chance to find the desired item there. And sellers will naturally want to list their items in the marketplace visited by the largest number of buyers, thereby increasing their chance (and possibly amount) of sale. A feedback loop is created where more buyers attract more sellers, and more sellers attract more buyers. Once an online marketplace becomes dominant in a field, new competitors find it extremely difficult to attract either buyers or sellers, regardless of the fee structure they offer.

The Consumer-To-Consumer online auction marketplace operated by eBay Inc. in the US is an excellent example of this feedback loop. By virtue of being the first successful such marketplace, it has attracted a very large community of buyers and sellers (over 27 million active users in December 2002). Over 12 million different items are listed for sale on eBay Inc.'s web site on any given day. Other similar online auction marketplaces have much smaller communities of users, and a much lower volume of listings. Because of the small number of buyers on the smaller marketplaces, there is less competition for any given item, causing the prices realized to be much lower. As a result, listing items for sale on these smaller marketplaces is not attractive to most sellers, and they prefer listing on eBay's online marketplace, even though eBay's fees may be higher. The smaller auction marketplaces are not successful in attracting buyers (because there are not enough items listed for sale) or sellers (because there are not enough buyers browsing the auction listings).

When an online marketplace becomes a de-facto monopoly, the drawbacks normally associated with monopolies may apply. For example, the online marketplace may require its users to pay higher fees than it would be able to do in a competitive situation, may have less incentive to improve the service it provides to its users, and may not be overly concerned about issues such as customer satisfaction.

Various techniques have been attempted by smaller Consumer-to-Consumer online marketplaces in order to grab market share from established online marketplaces, the most common one being to reduce and even eliminate the fees associated to listing and selling items. The problem with this approach is that it increased the listing of items of little value and dubious interest, without attracting users selling higher end items.

To date, no method has been found that allows smaller Consumer-to-Consumer online marketplaces to successfully compete against established online marketplaces. This is especially obvious in the domain of Consumer-to-Consumer online auctions in the US where attempts to gain market share from eBay Inc. by companies such as Yahoo! Inc, Amazon.com Inc, and others have been largely unsuccessful.

### SUMMARY

The present invention provides a method and system allowing a competitor online marketplace to effectively compete against an already established online marketplace. By widely distributing a software application that users may use to interact with online marketplaces, it is possible to provide an integrated view of the items available for sale in the competitor online marketplace along with those from the established online marketplace. Thus, by virtue of this integration, the users of the software application become buyers in the competitor online marketplace as well as in the established online marketplace. It is important to maximize the distribution of the software application, by for example bundling it with operating systems, and to encourage its use by providing features not easily available when online marketplaces are accessed using a web browser.

### DRAWINGS

FIG. 1 shows a general overview of an online marketplace accessed from client computers over a network.

FIG. 2 shows users accessing an online marketplace using a web browser.

FIG. 3 shows users accessing an online marketplace using a software application, which displays items from both the established online marketplace and the competitor online marketplace.

### DETAILED DESCRIPTION

### Online Marketplace

An online marketplace is a service in which items are offered for sale or auction, and which allows a large number of users to bid on or purchase items currently offered on the online marketplace. In online marketplaces, items are offered for sale or auction by one or many of the following: (a) the operator of the online marketplace; (b) a third party; (c) any user of the online marketplace. Users of online marketplaces typically are scattered across a large geographical area, and communicate with the computer system(s) running the online marketplace by using a personal computer or other computing device. This communication between the online marketplace users and the online marketplace is performed via communication protocols such as TCP/IP, and takes place on a wide area network such as the Internet.

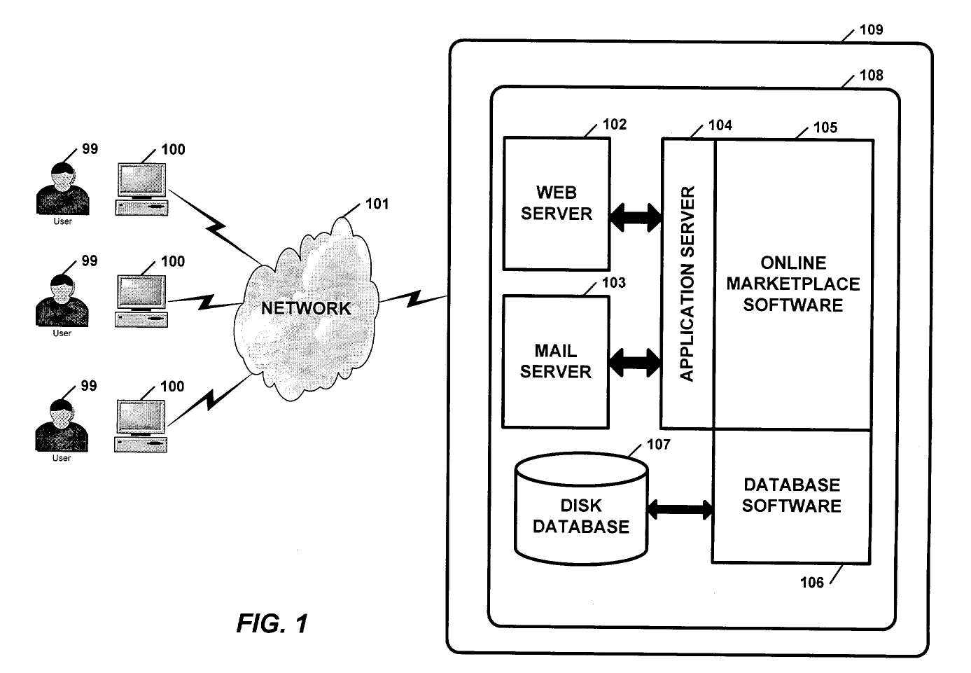

FIG. 1 provides an overview of the online marketplace. A large number of users 99 use client computers 100 connected to a network 101 to access online marketplace web site 108, hosted on server computer system 109. In practice, server computer system 109 may not be a single monolithic server computer, but rather a network of interconnected server computers, possibly physically dispersed from each other, each dedicated to its own set of duties and/or to a particular geographical region. Online marketplace web site 108 is powered by a number of software packages, which may include: a web server 102, responsible for the interaction with client computers 100 using a protocol such as HTTP; a mail server 103 responsible for delivering email messages; an application server 104 providing fundamental building blocks for developing web applications; database management software 106 providing services for storing and retrieving data records on disk database 107; and finally online marketplace software 105 implementing the custom methods of the online marketplace.

### Items

An item, offered for sale in an online marketplace, may be anything which can conceivably be purchased, including objects, properties and services. Examples of items include: collectible objects; electronic devices such as consumer electronics and computer devices; automobiles; photographic equipment; jewelry; musical instruments; real estate such as homes, land, commercial and timeshares; plane tickets; hotel, car rental or other travel services; intellectual property such as patent deeds; clothing; event tickets; professional services such as translation; etc . . .

### Buyers and Sellers

A buyer is any user of an online marketplace who has purchased at least one item from the online marketplace. A seller is any user of an online marketplace who has listed at least one item for sale in the online marketplace. A user of an online marketplace can be a buyer, a seller, or both. A user who browses items listed for sale in an online marketplace, but which hasn't purchased any yet, is also considered a buyer.

### Established Online Marketplace

An established online marketplace is an online marketplace which has gained a significant market share in the domain it occupies. This market share is usually measured in total amount of goods sold, but other metrics could be used such as: the average number of different items available for sale; the average number of transactions concluded per day. A good example of an established online marketplace in the domain of Consumer-to-Consumer online auctions is eBay Inc., which has a US market share (measured in total value of items sold) of about ninety percent, and is by far the most important established online marketplace in this domain.

### Competitor Online Marketplace

A competitor online marketplace is an online marketplace which has not yet gained a significant market share in the domain it occupies. The goal of the present invention is to provide a method and system which will allow the competitor online marketplace to effectively compete and gain market share against an established online marketplace.

### Accessing Online Marketplaces with a Generic Web Browser

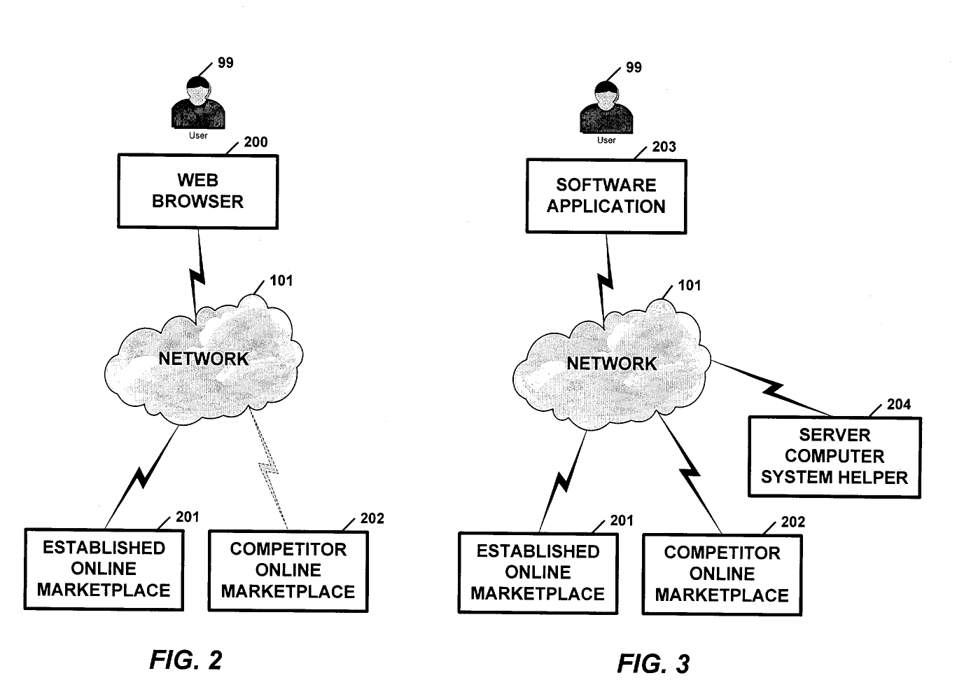

As shown in FIG. 2, users 99 usually access established online marketplace 201 across network 101 by using web browser 200. Web browser 200 is a generic software application, allowing to access a large variety of web sites, Examples of web browser 200 include: Internet Explorer provided by Microsoft Corporation; and Netscape provided by Netscape Communications Corp. In order to visit an online marketplace, users 99 need to specify the address of the online marketplace they wish to visit. This address specification is commonly achieved either by typing in the address in a text field, or by selecting it from a bookmark or favorites list. Once the address has been selected in the web browser, the web site of the specified online marketplace is displayed within the browser window, and only the items available for sale in this online marketplace are presented to the user.

For the sake of simplicity, FIG. 2 shows only two online marketplaces: established online marketplace 201; and competitor online marketplace 202. However, The method and system disclosed in the present invention is not limited to this simple case, and applies as well when competitor online marketplace 202 is attempting to gain market share from multiple established online marketplaces 201.

FIG. 2. shows that, when using web browser 200, most users 99 will choose to interact with the web site of established online marketplace 201. If users 99 are interested in purchasing an item, they will naturally select the online marketplace with the greatest selection of items, and this normally is established online marketplace 201. The same applies for users 99 interested in selling an item, who will prefer to list items in established online marketplace 201, because it is visited by a large number of buyers.

### Accessing Online Marketplaces with a Specialized Software Application

The method and system disclosed in the present invention aims to significantly increase the number of buyers that the items for sale on competitor online marketplace 202 are exposed to. As shown in FIG. 3, this is achieved by creating and distributing software application 203, which allows users to access directly online marketplaces without having to enter web site addresses in a web browser.

Software application 203 is a key part of the method and system disclosed in the present invention. It is a computer program which, when installed on client computers 100, allows end users 99 to interact with multiple online marketplaces, including established online marketplace 201 and competitor online marketplace 202. Software application 203 should provide compelling advantages to users in comparison to the use of web browser 200, and should be distributed as widely as possible. If this is achieved, a large number of users 99 will prefer using software application 203 instead of web browser 200 to access established online marketplace 201. When users 99, using software application 203, request searches or category listings, items from both established online marketplace 201 and competitor online marketplace 202 are displayed. This will dramatically increase the number of buyers that the items for sale on competitor online marketplace 202 are exposed to.

Examples of functionalities which may be included in software application 203 include:

Acting as a proxy for accessing the online marketplaces, and allowing to perform most or all of the functions which can be performed using a web browser connected to the online marketplace's web site. This include: listing items by categories; searching for items by keywords or other characteristics; displaying items and all current attributes; bid, or purchase, an item; display user feedback, display information about items purchase or sold recently; display account balance and preferences; leave feedback; etc.

Providing auction sniping functionality. An auction sniping service stores the maximum amount that a user is willing to pay for an item, and places the bid with the online auction marketplace within the last seconds of an auction. In some cases, using auction sniping enables a user to win an auction for a lesser amount than if the bid has been placed earlier, because it doesn't allow time for other bidders to react. Sniping services are most useful when powered by one or more servers permanently connected to network 101. Not only can these servers maintain an accurate clock by synchronizing with a time-reference server, but they also remove the requirement for client computer 100 to be connected to network 101 when the auctions to be sniped are about to end.

Providing an automatic search and notification service: this service would allow users 100 to register a list of searches, which would automatically be run at regular intervals, and notifications of matching items would be sent (usually in the form of email messages).

Providing web acceleration by downloading web pages in the background, so they will display faster when requested by the user. For example, if a search returns a list of five items, items two to five may be downloaded while the user reads the first item, providing instant access to those items when needed. This can be a drastic improvement for users with a slow network connection.

Providing access to multiple online marketplaces using a unified interface. This can be a compelling advantage to buyers, as it would allow them to search or browse multiple online marketplaces in a single step, ensuring that items for sale in smaller online marketplaces are found as well.

Managing the item purchasing and sale process. Especially in the case of Consumer-to-Consumer online auctions, a communication is necessary between buyer and seller to arrange payment and shipping. When a large number of items are purchased or sold, it is helpful to have to tool to help manage this process.

Providing multiple features targeted towards sellers, including: creation of item listings; scheduling of these listings for posting on various online marketplaces; automated customer notifications; inventory management; accounting; taxes; edition of shipping and postage labels; automated relisting tools; online storefront independent from the online marketplace.

Software application 203 can take multiple forms. It can be a standalone application, dedicated to accessing online marketplaces. It can also take the form of an extended web browser, which would include specific functionality for locating and listing items for sale in online marketplaces.

It can also take the form of a toolbar or other application extension, which can be integrated within a web browser or another application, providing additional functionality to an existing application.

### Distribution of Software Application 203

Software application 203 should be distributed as widely as possible, to ensure it will be used by a maximum number of users. One of the best method for ensuring wide distribution of software application 203 would be to bundle it with operating systems distributions. For example, an agreement could be reached with Microsoft Corporation to bundle software application 203 with various versions of the Windows operating system, such as Windows XP. This would ensure the availability of software application 203 immediately after the installation of the operating system on client computers 100.

Another method for ensuring the wide distribution of software application 203 would be to include it with the software package distributed by popular Internet Service Providers such as America Online Inc. Yet another distribution method would be to make software application 203 available as a free download from a web site, but this would probably require additional marketing to ensure that a significant number of users download and install it.

### Server Computer System Helper

It should be noted that the functions of software application 203 need not be performed fully on client computer 100. Indeed, as shown in FIG. 3, it is advantageous for software application 203 to work in concert with server computer system helper 204. In practice, server computer system helper 204 may not be a single monolithic server computer, but rather a network of interconnected server computers, possibly physically dispersed from each other, each dedicated to its own set of duties and/or to a particular geographical region.

A service that can be advantageously provided by server computer system helper 204 is auction sniping. After users input the information regarding the items to be sniped and the maximum bid amount, this information may be transmitted across network 101 to server computer system helper 204, which will actually perform the sniping by transmitting the user's bid to the online marketplace's web site within the last few seconds of the auction. Because server computer system helper 204 can benefit from a fast and permanent network connection, and can maintain an accurate clock by synchronizing with reference time servers, this configuration will ensure that the sniping service is accurately performed, regardless of the state of the computer running software application 203.

Server computer system helper 204 may also provide caching services, such as retaining the descriptions of items available for sale in various online marketplaces. This may help reduce the load of requests directed towards those online marketplaces, may allow more responsive interaction between users and software application 203, and may also allow software application 203 to support advanced features not available from the online marketplace's web sites, such as searching for items using regular expressions.

Another service rendered by server computer system helper 204 may be to provide a source for automatic updates to software application 203. Indeed, interfaces for accessing various online marketplaces may change over time, requiring incremental updates to installations of software application 203. This can be achieved by having software application 203 check for updates at regular intervals, by connecting to server computer system helper 204, and downloading and installing the updates upon availability.

### Conclusion, Ramifications and Scope of Invention

Thus the reader will see that the method and system of the invention allows a smaller competitor online marketplace to compete more effectively against an established online marketplace, regardless of the market share gap which may exist between these two online marketplaces. By distributing and encouraging the use of a software application which allows simple simultaneous interaction with multiple online marketplaces, the operator of the competitor online marketplace significantly reduces the handicap of being a smaller entity, without a large base of buyers and/or sellers.

The increased competition among online marketplaces, which will result from the application of the present invention, can only benefit the larger community of buyers and sellers with effects such as: the lowering of fees levied by online marketplaces; better service and customer support; and the availability of more and better tools and services.

While the above description contains many specificities, these should not be construed as limitations on the scope of the invention, but rather as an exemplification of one preferred embodiment thereof. Accordingly, the scope of the invention should be determined not by the embodiment illustrated, but by the appended claims and their legal equivalents.

In the claims which follow, reference characters used to denote process steps are provided for convenience of description only, and not to imply a particular order for performing the steps or that the steps are not overlapping.

I claim:

1. A method for competing against at least one established online marketplace, the method comprising the steps of:
(a) providing a competitor online marketplace;
(b) distributing to a plurality of users a software application which allows said users to interact with the established online marketplace, and which presents to said users at least one item available for sale in the competitor online marketplace.

2. The method of claim 1, wherein the software application is bundled with an operating system distribution.

3. The method of claim 1, wherein the software application is bundled with an Internet Service Provider software distribution.

4. The method of claim 1, wherein the software application is a browser extension.

5. The method of claim 4, wherein the software application is bundled with a browser distribution.

6. The method of claim 1, wherein the software application is a customized browser.

7. A computer program embodied on a computer-readable medium, comprising:
(a) a server computer code segment for residence on a server computer system, which provides the functionality of a competitor online marketplace;
(b) a client computer code segment for residence on a plurality of client computer systems, which allows a plurality of users to interact with at least one established online marketplace, and which presents to said users at least one item available for sale in the competitor online marketplace.

8. The computer program of claim 7, wherein the client computer code segment is bundled with an operating system distribution.

9. The computer program of claim 7, wherein the client computer code segment is bundled with an Internet Service Provider software distribution.

10. The computer program of claim 7, wherein the client computer code segment is a browser extension.

11. The computer program of claim 9, wherein the client computer code segment is bundled with a browser distribution.

12. The computer program of claim 7, wherein the client computer code segment is a customized browser.
